(19) United States
(12) Patent Application Publication
(10) Pub. No.: US 2017/0011365 A1
(43) Pub. Date: Jan. 12, 2017

(54) METHODS AND COMPUTER PROGRAMS FOR EFFICIENT PAYMENTS USING DIGITAL PROMISSORY NOTES

(71) Applicant: Strawpay AB, Stockholm (SE)

(72) Inventors: Jarl Fransson, Stockholm (SE); Martin Zachrison, Nacka (SE)

(21) Appl. No.: 15/205,010

(22) Filed: Jul. 8, 2016

Related U.S. Application Data
(60) Provisional application No. 62/190,830, filed on Jul. 10, 2015.

(51) Int. Cl. G06Q 20/06; G06Q 20/02; G06Q 20/38; G06Q 20/32; G06Q 20/10

(52) U.S. Cl. CPC G06Q 20/06; G06Q 20/322; G06Q 20/105; G06Q 20/3821; G06Q 20/3825; G06Q 20/3829; G06Q 20/3823; G06Q 20/3827; G06Q 20/02

(57) ABSTRACT

A method performed by a computer implemented method performed by an issuer device for providing a promissory note as a means of payment to a user device and enabling a redemption payment transaction based on the promissory note to a last bearer device is provided. The issuer device issues a promissory note as a first digital information carrier. The issuer device then transmits the promissory note as the first digital information carrier to the user device. The issuer device also receives the promissory note as a second digital information carrier from the last bearer device. The issuer device then proceeds with the redemption payment transaction based on the promissory note to the last bearer device.

This application claims priority to U.S. Provisional Application No. 62/190,830, filed 10 Jul. 2015, the entire contents of which is hereby incorporated by reference.

### BACKGROUND

In a digital context, in which duplication of a data is trivial, there is a need for a way for recipients of payments to assure that a payment is valid. Thus, in this digital context, the fact that the same digital token may be transferred to any number of different recipients demonstrates the so-called double-spending problem for digital tokens.

One way to handle this problem is to use some form of contract of payment which, upon receipt, is immediately redeemed at the party which issued or guaranteed the contract. Alternatively, the validity of the contract is immediately verified at the party which issued or guaranteed the contract. This contract of payment represents a claim for a sum of money on the party that issued or guaranteed said contract.

One example of such a contract of payment is a promissory note. A promissory note may be defined as a contract or base contract comprising a set of attributes or specifications that codifies a promise to pay an amount or sum of money set by specified terms. A standard promissory note embodies a promise to pay the holder or bearer of the promissory note an amount or sum of money unconditionally according to terms defined in the writing of the promissory note. A promissory note is a financial instrument which has a well-defined meaning in most jurisdictions.

Unfortunately, using this way to handle the double spending problem has various consequences, one being that each payment transaction then needs to be verified by an always online central party, i.e. the party which issued or guaranteed the digital contract must always be able to be immediately reached by a redeeming or verifying party, before the contract can safely be accepted as payment.

### SUMMARY

An object of embodiments herein is to provide an improved method of efficient payments.

According to an aspect of embodiments herein, the object is achieved by providing a computer implemented method performed by an issuer device for providing a promissory note as a means of payment to a user device and enabling a redemption payment transaction based on the promissory note to a last bearer device. The issuer device issues a promissory note as a first digital information carrier comprising a first and second data part. The first data part comprises information associated with the promise of the promissory note, wherein the information comprises a unique identity of the promise of the promissory note, a public key of the issuer device, a monetary amount and a validity time. The second data part comprise a record of the transfer of ownership of the issued promissory note to the user device. The record comprises a public key of the user device, and a digital signature. The digital signature authenticates the record and the first data part with the public key of the issuer device. Also, the issuer device transmits the promissory note as the first digital information carrier to the user device.

Further, the issuer device receives the promissory note as a second digital information carrier from the last bearer device. The second digital information carrier comprises the first data part of the first digital information carrier, and a second data part. The second data part comprises an ordered list of records in which the first record is the record of the second data part of the first digital information carrier, and subsequent records are any subsequent transfers of ownership of the promissory note, up to and including the transfer from the last bearer device back to the issuer device. Each subsequent record comprises a public key of an assigned owner and a digital signature of the previous owner, wherein the digital signature authenticates the record itself, the records of all previous transfers, and the first data part. Then, the issuer device proceeds with the redemption payment transaction based on the promissory note to the last bearer device when: the digital signature of each record in the second data part in the second digital information carrier have been verified using each respective public key, the information associated with the promise of the promissory note in the first data part is valid, and no redemption payment transaction has previously been made to redeem the promise of the promissory note in the first data part.

According to another aspect of embodiments herein, the object is achieved by providing a computer implemented method performed by a last bearer device for receiving a promissory note as a means of payment and enabling a redemption payment transaction based on the promissory note at an issuer device. The last bearer device receives a promissory note as a first digital information carrier comprising a first and second data part. The first data part comprises information associated with the promise of the promissory note. The information comprises a unique identity of the promise of the promissory note, a public key of the issuer device, a monetary amount, and a validity time. The second data part comprises an ordered list of records, where the ordered list comprises a record of the transfer of ownership of the issued promissory note to a user device and subsequent records of any subsequent transfers of ownership of the promissory note, up to and including the transfer from a previous bearer device to the last bearer device. Each record comprises a public key of the assigned owner and a digital signature of the previous owner, where the digital signature authenticates the record itself, the records of all previous transfers, and the first data part. Also, the last bearer device determines that the promissory note is a valid payment to the last bearer device when: the digital signature of each record in the second data part have been verified using each respective public key, and the information associated with the promise of the promissory note in the first data part is valid.

Further, the last bearer device generates a second digital information carrier comprising the first data part of the first digital information carrier and the second data part of the first digital information carrier. In the second data part, an additional record is added to the ordered list of records, which additional record is a record of the transfer of ownership of the promissory note to the issuer device. The additional record comprises a public key of the issuer device, and a digital signature of the last bearer device. The digital signature authenticates the additional record itself, the records of all previous transfers, and the first data part. Then, the last bearer device transmits the second digital information carrier to the issuer device.

According to yet another aspect of embodiments herein, the object is achieved by providing a computer program product, comprising instructions which, when executed on at least one processor, cause the at least one processor to carry out the steps indicated above for the issuer device.

According to a further aspect of embodiments herein, the object is achieved by providing a computer program product, comprising instructions which, when executed on at least one processor, cause the at least one processor to carry out the steps indicated above for the last bearer device.

By enabling an issuer device and a last bearer device to construct a digital promissory note as described above, an efficient and secure redemption payment transaction may be achieved from the issuer device to the last bearer device.

### BRIEF DESCRIPTION OF THE DRAWINGS

Examples of embodiments herein are described in more detail with reference to the accompanying drawings, in which:

FIG. 1 is a schematic illustration of a communications network comprising embodiments of an issuer device and bearer device.

FIG. 2 is a schematic block diagram illustrating embodiments of an issuer device.

FIG. 3 is a schematic block diagram illustrating embodiments of a bearer device.

FIG. 4 is a flowchart depicting embodiments of a method in an issuer device.

FIG. 5 is a flowchart depicting embodiments of a method in a bearer device.

FIG. 6 is a diagram illustrating communications for a user device payment and for a bearer device redemption payment.

FIG. 7 is a flowchart depicting embodiments of a method in an issuer device.

FIG. 8 is a flowchart depicting embodiments of a method in a bearer device.

### DETAILED DESCRIPTION

The following commonly terminologies are used in the embodiments and are elaborated below.

Digital Promissory Note:

In some embodiments, a non-limiting term digital promissory note, or simply, promissory note, is used. This term as used herein may be referred to as digital information describing the contract, base contract, or promise of the promissory note, i.e. a digital version of the promissory note. The term promissory note may interchangeably be referred to as contract of payment, note payable, note, or bank note. A digital promissory note is a digital negotiable contract that may be used to transfer value.

Issuer Device:

In some embodiments, a non-limiting term issuer device is used. A bearer device may be defined as a device whose identity in the form of an authentic digital signature may be verified by a public key used by the bearer device and at some point may be the issuer of a promissory note to a user device. One example of an issuer device is one or more communication nodes or servers in a communications network, which communication nodes or servers belongs to a party, e.g. an issuer, equipped or authorized to issue digital promissory notes to its users or user devices.

Bearer Device:

In some embodiments, a non-limiting term bearer device is used. A bearer device may be defined as a device whose identity in the form of an authentic digital signature may be verified by a public key used by the bearer device and at some point may be the bearer or holder of a promissory note. One example of a bearer device is one or more communication nodes or servers in a communications network, which communication nodes or servers belongs to a party, e.g. a merchant of goods and services, providing a product or service to the user of the user device.

User Device:

In some embodiments, a non-limiting term user device is used and it refers to and may be defined as a device that may be used by a consumer to employ the services of an issuer device, e.g. an issuer, in order to transfer value to a bearer device, e.g. a merchant, in exchange for a product or service. One example is a conventional computer connected to the internet. A user device may also be a bearer device.

Digital Information Carrier:

In some embodiments, a non-limiting term digital information carrier is used to refer to a digital construct or data packet that may comprise digital information.

Public Key and Digital Signature:

The terms public key and digital signature refers to concepts defined in a cryptographic constructions of digital signature schemes. Each, may here also refer to any data that can fill a similar secure role where the signing algorithm and verifying algorithm can functionally depend on some external database such as for example an email address, or names, etc, where a unique identifier can be used instead of a cryptographic public key, or indisputably identify some public key by external lookup mechanism.

Redacted, Redactable Digital Signatures:

Something that is redacted or removed from a message that is signed using a digital signature, but in such a way that the signature can still be verified for the parts that have not been redacted from the message. Organizing parts of a message in a list or tree of parts where the message is signed by first creating hash values for the elements in the list or tree means that the parts are redactable.

Authenticated Information:

Information that is authenticated with a digital signature and a public key. The fact that is established about the information by the signature is that the information was signed by a secret key that corresponds to the public key and that the information has not been changed.

Nonce:

A cryptographic nonce is an arbitrary number that may only be used once.

Negotiable Instrument:

Something of value, usually stated in a financial contract or obligation, that can be negotiated, meaning that the ownership can be transferred. A promissory note is an example of a negotiable instrument. A number of negotiable instruments can be packed together to form a negotiable instrument.

Transfer of Ownership:

The process performed by an owner of a promissory note when the owner assigns a new owner and authorizes the transfer. In the context of negotiable instruments, to perform this transfer process is also called to negotiate the instrument.

Monetary Amount:

A specification comprising of an expressed numerical value and a monetary asset, e.g. a established currency or other liquid asset type. The monetary asset may specify a particular contract that includes terms such as counterparty representing the asset's issuer, due dates etc.

Payment Transaction:

Within some group of actors, an established way of transferring monetary value from one entity, payer, to another entity, payee, where entities may be private person, corporate, or machine agents.

Redemption Payment Transaction:

A payment received in exchange for a redeeming a promissory note, usually by transferring it to the issuer of the promissory note, or to an intermediary that eventually will transfer the promissory note to the issuer. The redemption payment corresponds to the terms of the promise, such as amount and currency, but the redemption payment can be made in any way that is acceptable to the two parties involved, such as expressed in other preferred currency, using a designated bank, payment network etc.

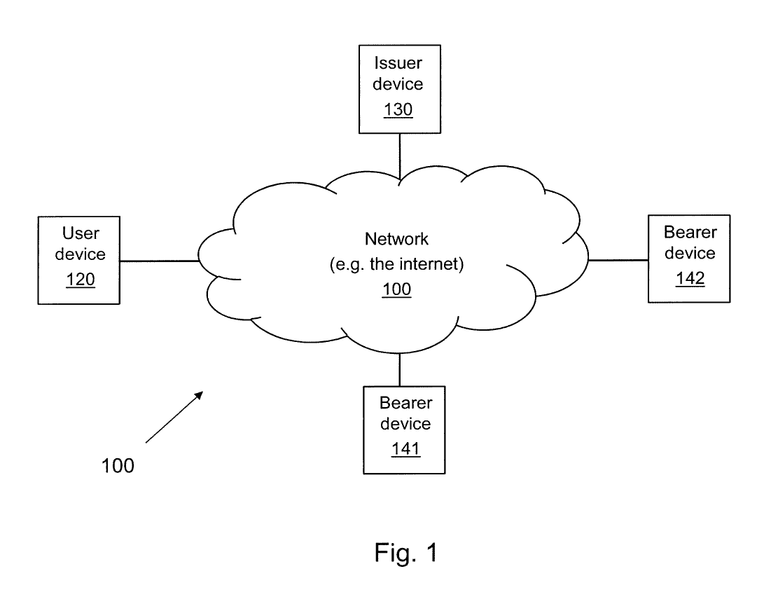

FIG. 1 depicts an example of a communications network 100. The wireless communications network 100 may comprise a plurality of network nodes, whereof a user device 120, a issuer device 130, a first bearer device 141 and a second bearer device 142 are depicted in FIG. 1. The communication network 100 also comprise a network 101 through which the user device 120, the issuer device 130, the first bearer device 141 and the second bearer device 142 are configured to communicate, such as, e.g. the internet.

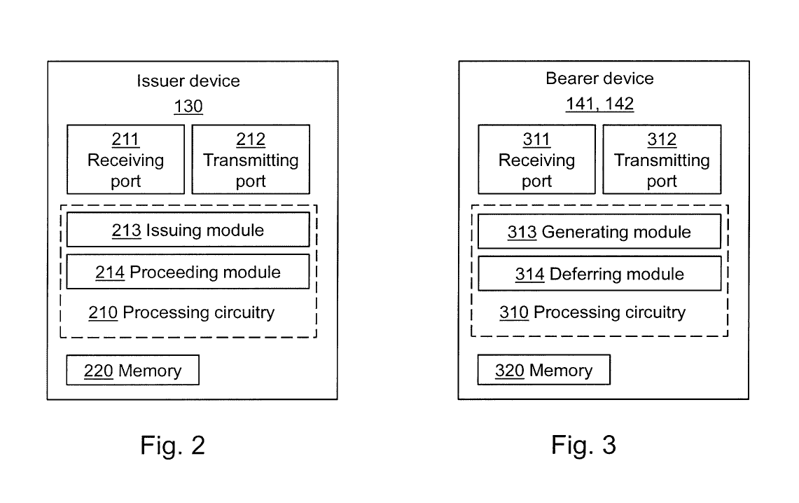

FIG. 2 depicts an example of embodiments of an issuer device 130.

FIG. 3 depicts an example of embodiments of a bearer device 141, 142.

These embodiments may be implemented through one or more processors, such as a processor 210 in the issuer device 130 depicted in FIG. 1 and a processor 310 in the bearer device 141, 142 depicted in FIG. 3, together with computer program code for performing the functions and actions of the embodiments herein. The program code mentioned above may also be provided as a computer program product, for instance in the form of a data carrier carrying computer program code for performing the embodiments herein when being loaded into the issuer device 130 and the bearer device 141, 142. One such carrier may be in the form of a CD ROM disc. It is however feasible with other data carriers such as a memory stick. The computer program code may furthermore be provided as pure program code on a server and downloaded to the issuer device 130 and the bearer device 141, 142.

The issuer device 130 and the bearer device 141, 142 may further comprise a memory 220, 320, respectively, which each may comprising one or more memory units. The memories 220, 320 are respectively arranged to be used to store information in order to perform the methods described according to the embodiments herein when being executed in the issuer device 130 and the bearer device 141, 142, respectively.

In some embodiments, the issuer device 130 and the bearer device 141, 142 may receive information through a receiving port 211, 311, respectively. In some embodiments, the issuer device 130 and the bearer device 141, 142 may receive information from another device in the communications network 100 through their respective receiving ports 211, 311. Since the receiving port 211, 311 may be in communication with the processor 210, 310, respectively, the receiving port 211, 311 may then send the received information to the processor 210, 310. The receiving port 211, 311 may also be configured to receive other information. The processor 210, 310 in the issuer device 130 and the bearer device 141, 142 may be further configured to transmit or send information through a respective transmitting port 212, which may be in communication with the processor 210, 310 and the memory 220, 320, respectively.

In some embodiments, the issuer device 130 may also comprise a issuing module 213 and a proceeding module 214 for executing the methods described according to the embodiments of the issuer device 130 herein.

Those skilled in the art will also appreciate that the issuing module 213 and the proceeding module 214 may refer to a combination of analog and digital modules, and/or one or more processors configured with software and/or firmware, e.g., stored in memory, that, when executed by the one or more processors such as the processor 210, perform the methods as described below. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC). Also, in some embodiments, the issuing module 213 and the proceeding module 214 may be implemented as one or more applications running on one or more processors such as the processor 210.

Thus, the methods according to the embodiments described herein for the issuer device 130 may be implemented by means of a computer program product, comprising instructions, i.e., software code portions, which, when executed on at least one processor, cause the at least one processor to carry out the actions described herein, as performed by the issuer device 130. The computer program product may be stored on a computer-readable storage medium. The computer-readable storage medium, having stored thereon the computer program, may comprise instructions which, when executed on at least one processor, cause the at least one processor to carry out the actions described herein, as performed by the issuer device 130. In some embodiments, the computer-readable storage medium may be a non-transitory computer-readable storage medium, such as a CD ROM disc, or a memory stick. In other embodiments, the computer program product may be stored on a carrier comprising the computer program just described, wherein the carrier is one of an electronic signal, optical signal, radio signal, or the computer-readable storage medium, as described above.

In some embodiments, the bearer device 141, 142 may also comprise a generating module 313 and a deferring module 314 for executing the methods described according to the embodiments of the bearer device 141, 142 herein.

Those skilled in the art will also appreciate that the generating module 313 and the deferring module 314 may refer to a combination of analog and digital modules, and/or one or more processors configured with software and/or firmware, e.g., stored in memory, that, when executed by the one or more processors such as the processor 310, perform the methods as described below. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC). Also, in some embodiments, the generating module 313 and deferring module 314 may be implemented as one or more applications running on one or more processors such as the processor 310.

Thus, the methods according to the embodiments described herein for the bearer device 141, 142 may be implemented by means of a computer program product, comprising instructions, i.e., software code portions, which, when executed on at least one processor, cause the at least one processor to carry out the actions described herein, as performed by the bearer device 141, 142. The computer program product may be stored on a computer-readable storage medium. The computer-readable storage medium, having stored thereon the computer program, may comprise instructions which, when executed on at least one processor, cause the at least one processor to carry out the actions described herein, as performed by the bearer device 141, 142. In some embodiments, the computer-readable storage medium may be a non-transitory computer-readable storage medium, such as a CD ROM disc, or a memory stick. In other embodiments, the computer program product may be stored on a carrier comprising the computer program just described, wherein the carrier is one of an electronic signal, optical signal, radio signal, or the computer-readable storage medium, as described above.

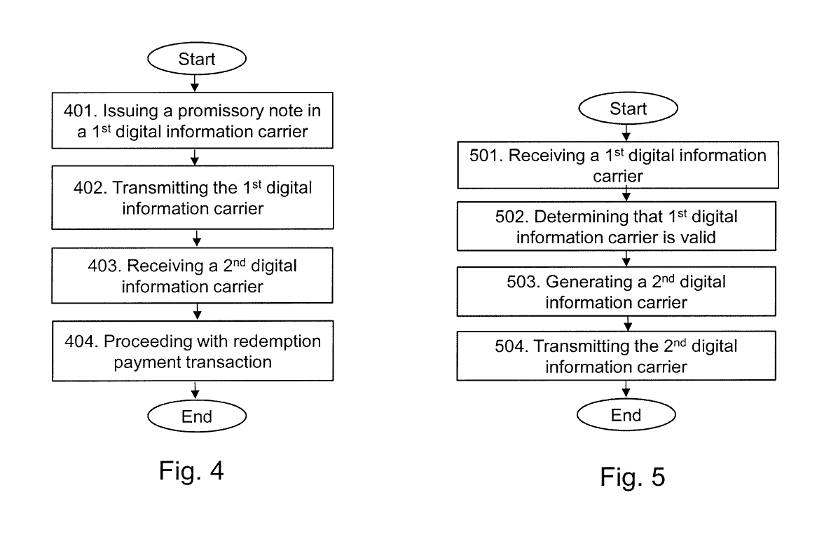

Example of embodiments of a method performed by the issuer device 130 for enabling a payment transaction to a first bearer device 141 on behalf of a user device 120 will now be described with reference to the flowchart depicted in FIG. 4.

FIG. 4 is an illustrated example of actions or operations which may be taken or performed by the issuer device 130. The method may comprise the following actions.

Action 401

First, the issuer device 130 may generate a first digital information carrier. The first digital information carrier may comprise a first and a second data part. The first data part may comprise information associated with an issued promissory note of an amount corresponding to the payment transaction. The first data part may also be referred to as a promissory note or base contract in some embodiments. The second data part may comprise a first record. The second data part may also be referred to as a negotiation list, negotiation record, chain of negotiations, or chain of endorsements in some embodiments. The first record may be a record of the transfer of ownership of the issued promissory note to the user device 120, wherein the record is signed by an authentic digital signature using a public key of the issuer device.

Action 402

After the generating the first digital information carrier, the issuer device 130 may transmit the first digital information carrier to the user device 120.

Action 403

In this action, the issuer device 130 may subsequently receive a second digital information carrier from the first bearer device 141. The second digital information carrier may comprise the first data part of the first digital information carrier. The second digital information carrier may also comprise a second data part comprising a number of records. The number of records in the second data part may comprise the first record of the second data part of the first digital information carrier, and a record of each subsequent transfer of ownership of the promissory note to a bearer device up to and including the transfer of ownership of the promissory note from the first bearer device 141 back to the issuer device 130, wherein each record is signed by an authentic digital signature using a public key of the previous bearer device.

Action 404

In this action, the issuer device 130 may proceed with the payment transaction to the first bearer device 141 when the payment transaction to the first bearer device when each authentic digital signature of each record in the second data part in the second digital information carrier have been verified using each respective public key.

Example of embodiments of a method performed by the first bearer device 141 for enabling a payment transaction on behalf of a user device 120 by an issuer device 130 will now be described with reference to the flowchart depicted in FIG. 5.

FIG. 5 is an illustrated example of actions or operations which may be taken or performed by the first bearer device 141. The method may comprise the following actions.

Action 501

The first bearer device 141 may receive a first digital information carrier. The first digital information carrier may comprise a first data part and a second data part. The first data part may comprise information associated with an issued promissory note of an amount corresponding to the payment transaction. The second data part may comprise a number of records, which number of records comprises a record of each previous transfer of ownership of the promissory note to a bearer device up to and including the transfer of ownership of the promissory note to the first bearer device, wherein each record is signed by an authentic digital signature of the previous bearer device using a public key of the previous bearer device.

Action 502

After receiving the first digital information carrier, the first bearer device 141 may validate the first digital information carrier comprising a first data part and a second data part. The first data part is valid if the promise is valid according to the validity time and other terms specified. The second data part is valid if the digital signature of each record in the second data part in the first digital information carrier is authentic.

Action 503

After validating the first digital information carrier, the first bearer device 141 may generate a second digital information carrier comprising a first data part and a second data part. The first data part may comprise the first data part of the first digital information carrier. The second data part may comprise the second data part of the first digital information carrier, wherein an additional record has been added to the number of records, which additional record is a record of the transfer of ownership of the issued promissory note to the issuer device or to another bearer device signed by an authentic digital signature using a public key of the first bearer device.

Action 504

After generating the second digital information carrier, the first bearer device 141 may transmit the second digital information carrier to the issuer device 130 or to another bearer device 142.

In some embodiments, the first bearer device 141 may defer the transmission of the second digital information carrier to the issuer device 130, or to the other bearer device 142, until a determined number of digital information carriers are ready to be transmitted to the issuer device 130, or to the other bearer device 142.

Further examples of embodiments of the issuer device 130, the first bearer device 141 and methods therein is described below.

Construction

In somewhat different wording, the construction of a digital information carrier may comprise two parts, a base contract and a negotiation list.

The first part, i.e. the base contract, may comprise a set of attributes. For example, a set of attributes which may include, but not limited to, what is shown below in table 1.

| Attribute | Description |
|---|---|
| Legal text | Specifying the promise of the issuer. |
| Amount | The amount to be paid. |
| Currency | The currency of the amount. |
| Issuer name | The name of the issuer. |
| Issuer public key | The public key of the issuer. |
| Issued date | The date that the promissory note was issued. |
| Validity time | The redeemable validity time of the promissory note, |
| | starting from the issued date. |
| Double spend | An ordered list of future bearers, that will be required |
| verifiers | by the issuer before redemption occurs. Each verifier |
| | in the list can be assured that it will be the bearer of |
| | the note at some point during its life. |

### Table 1 Showing Example of a Set of Attributes of a Base Contract

The second part, i.e. the negotiation list, is a list of negotiation records, where each record in the list represents a transfer of ownership to a new bearer, i.e. bearer device 141, 142. The result is a bearer instrument since the rights holder is not identified by name or identity. Instead, for example, a pseudonymous public key may be used. In this case, anyone that may create an authentic digital signature, when verified with the public key of the last negotiation record, is considered the bearer of the instrument. As an example, each record in the negotiation list, i.e. second data part, may comprise the set of attributes shown below in Table 2.

| Attribute | Description |
|---|---|
| To the order of | Specifying the public key of the bearer. |
| Payment info | A cryptographic hash value of the Payment info attribute. |
| hash | |
| Signature | A digital signature created by the previous bearer of the |
| | promissory note. |

### Table 2 Showing an Example of a Set of Attributes of a Negotiation Record

In some embodiments, the issuer device 130 or the bearer device 141, 142 may also include arbitrary, or additional, information associated with the transfer of ownership in the negotiation list, i.e. the second data part. This arbitrary information may be attached within the digital information carrier by using a further a record in the negotiation list, e.g. as shown below in Table 3.

| Attribute | Description |
|---|---|
| Payment info | Redactable arbitrary information. The use and meaning of |
| | this attribute is left to the discretion of the parties involved |
| | in the negotiation. This attribute contains some data in the |
| | form of a byte string with an added nonce. |

### Table 3 Showing an Example of a Further Record of a Negotiation List, e.g. a Payment Information Record

In this case, the arbitrary information may be authenticated via its hash value and the authenticated digital signature of e.g. the issuer device 130, in the record for the transfer in the negotiation list, i.e. second data part.

In some embodiments, the issuing of a promissory note within a digital information carrier may optionally be done by the issuer device 130 by means of blind digital signature. The blind signature would encode some attributes of the base contract that defines the issuer's obligation, e.g. the currency, amount, date, validity time, e.g. as shown in Table 1. This optional step makes the redemption un-linkable to the issuance with the aim to improve consumer privacy.

In some embodiments, the public key and the authentic digital signatures may be generalized to more flexible cryptographic features. The generalization may include replacing public key attributes in the construction with attributes comprising proof requests, each a specification of a request of some cryptographic proof. Also, signature attributes are replaced by cryptographic proofs that satisfies proof request. In these embodiments, a valid signature may be a special case and a proof that satisfies a proof request requiring a valid signature over some data with a particular public key. Using these embodiments, it is possible to extend this to handle many types of signatures e.g. multi-party signatures etc.

Issuance

When the promissory note is issued, the attributes of the base contract in the first data information carrier and the attributes of the initial negotiation record in the first data information carrier are given values, i.e. content.

The issuer device 130 may then generate, i.e. create, an authentic digital signature that covers all attributes in the base contract and initial negotiation record. This authentic digital signature is then included in the initial negotiation record, i.e. the first record in the negotiation list or second data part. At this point in time, the negotiation list, i.e. second data part, may comprise only a single record value. In some embodiments, the issuer device 130 may also include the payment info record.

The issuer device 130 may then transfer the first information carrier to the user device 120 which may, for example, use it a payment in exchange for goods or services when communicating with e.g. a bearer device 141, 142.

The bearer of the newly issued promissory note, e.g. a user device 120 carrying the first data information carrier, may e.g. be defined in the To the order of-attribute. Or, more precisely, whoever can create an authentic digital signature as verified with the public key specified with the To the order of-attribute will be considered the bearer of promissory note indicated by the first data information carrier.

Even if the identity of the user, i.e. first bearer, is not part of the first data information carrier, the identity may optionally be demonstrated with a certificate that associates a public key with an identity. For example, a certificate is assumed to be a document from some authoritative source, certifying that a particular key is controlled, exclusively, by some party with a given identity.

Negotiation

The bearer, e.g. the bearer device 141, has the power to transfer the ownership to a new bearer, e.g. the bearer 142, by filling in and adding a negotiation record to the list of negotiations of the first data information carrier carrying the promissory note, i.e. generate a second data information carrier.

To complete the new negotiation record, the bearer, e.g. the first bearer device 141, generates an authentic digital signature that covers the promissory note, i.e. comprising the base contract, all previous negotiation records up to the newly added negotiation record attributes with the new bearer's public key, i.e. the public key of the second bearer 142, and the hash of any additional information in a payment info record.

For the latter, the point of inclusion of this hash in the authentic digital signature is to authenticate any attached information in the Payment Info-attribute. The Payment info-attribute may in this case not be included by the bearer device, i.e. the bearer device 141, in the negotiation record, i.e. the second data part, but may be attached in the first data information carrier carrying promissory note when it is sent to the other bearer device, e.g. the bearer device 142. One reason to use the hash instead of the full payment information is to allow the Payment info-attribute to be redacted at a later stage. Typically, only the last negotiation's Payment info-attribute is attached when the first data information carrier carrying promissory note is sent.

Redemption

Redemption of the promissory note carried in the first data information carrier occurs when its bearer, e.g. the bearer device 142, transfers a data information carrier back to the issuer, i.e. the issuer device 130, and demands that the issuer fulfil the promise of the promissory note carried in the data information carrier to pay the amount indicated in the promissory note therein.

This may be performed by the bearer, e.g. the bearer device 142, by negotiating the promissory note to the issuer, i.e. the issuer device 130, and, at the same time, supplying the issuer with redeem instructions within e.g. the Payment info-attribute. The authentic digital signatures of the promissory note carried in the data information carrier may be validated, for example, by verifying each authentic digital signature in the negotiation record of the negotiation list according to the public key present in each of the previous negation record in the negotiation list, and then finally, using the issuer's public key in the base contract to verify that the authentic digital signature of the first record of the list is correct. This validation may ultimately be performed at the issuer when redemption happens, but each new bearer may also validate all existing authentic digital signatures in order to know if the promissory note carried in a received data information carrier can be accepted as payment or not.

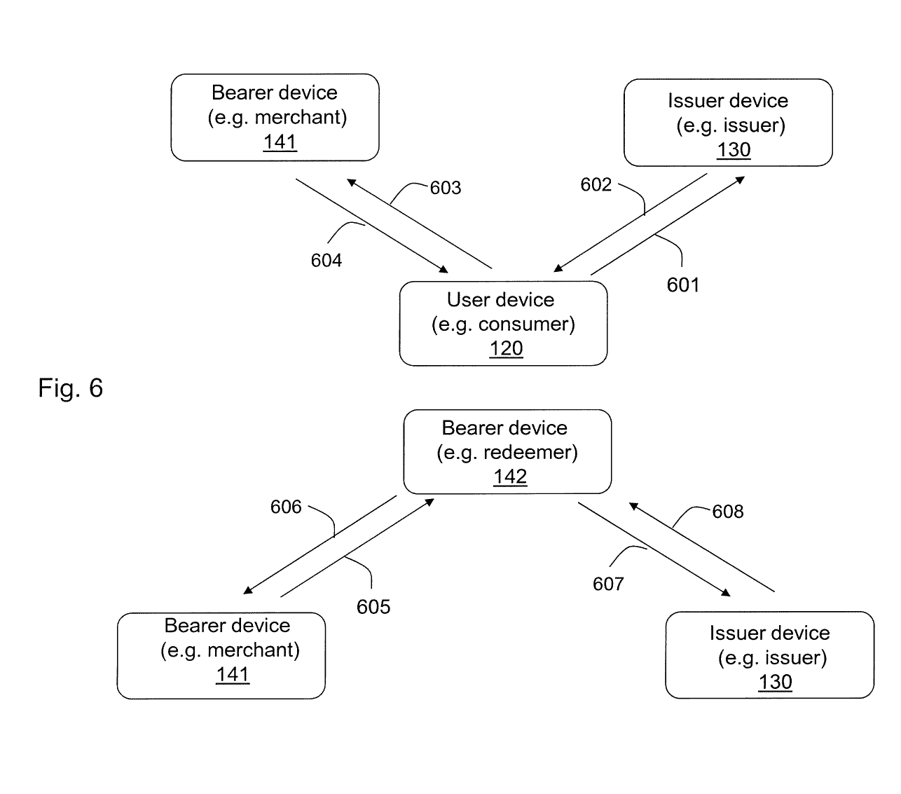

Further examples of embodiments of the issuer device 130, the first bearer device 141 and methods therein will now be described below with reference to the signalling charts illustrated in FIG. 6. FIG. 6 shows signalling charts illustrating how the first data information carrier may be used in trade.

To facilitate payments from consumers to merchants for goods and services, intermediaries act as hubs when they provide the services of issuing and redeeming promissory notes. The hubs could specialize in different roles: some hubs issue promissory notes for consumers to make payments, some redeem promissory notes when merchants demand payment, and some trade promissory notes between themselves. When a hub redeems other issuers' promissory notes from merchants and other hubs, it buys promissory notes at a discount representing a compensation for estimated risk and processing cost.

Consumer Payment

The upper part of FIG. 6 shows the roles and the interactions taking place when a payment is made. Actions 601-604 illustrates a transaction from a user acceptance of an offer to the delivery of a service.

Action 601.

When a consumer wishes to make a payment to a merchant for a service, this is done with the help of an issuer of promissory notes. The issuer is selected previously and is someone that must be accepted by the merchant. It could be said that, the consumer buys a promissory note with the amount and currency of the payment, in this case 0.05, from the issuer. How the consumer actually pays the issuer is ignored here, but the point is that the consumer-issuer relationship is regarded as a longer term. For example, a bitcoin payment channel may be used.

Action 602.

The issuer returns a newly issued promissory note to the consumer with the specified attributes, amount etc., according to the consumer's request.

Action 603.

The consumer transfers the promissory note to the merchant with added payment information specifying what is purchased.

Action 604.

The merchant validates and accepts the payment and delivers the service to the consumer.

The actions 601-604 may occur in sequence with no human interaction and will complete in a short period of time. Typically the payment is initiated when a user clicks to accept to pay, and as an immediate consequence the service appears.

Merchant Redemption

A condition for handling micro-transactions efficiently is to achieve high degree of transaction aggregation. This may be employed at different levels and in different bearer devices to reduce load and improve real-time properties. One example is that merchants can redeem a large number of promissory notes at their redeemer in one action.

The lower part of FIG. 6 shows the roles and the interactions taking place when a redemption is made.

Action 605.

When the merchant wishes to redeem one or more received promissory notes, these are negotiated in a single block to the redeemer selected by the merchant. To provide consumer privacy of the goods purchased, the merchant redacts any payment information previously supplied by consumers. The merchant also attaches details about how the redemption payment should be done. The redeemer can be the same party as the issuer but in general the redeemer accepts and redeems promissory notes issued by several issuers.

Action 606.

The redeemer validates the block and pays the sum of all the notes redeemed to the merchant according to terms agreed with the merchant, adjusting for discounting note values for various issuers. The terms may stipulate that the payment will be made once a certain amount to be paid has been accumulated at the redeemer.

Action 607.

The redeemer will handle the settlement process of transferring batches of promissory notes to the proper issuer.

Action 608.

The issuer finally pays the due amount according to discretionary terms between the two parties.

Further examples of embodiments of the issuer device 130, the first bearer device 141 and methods therein is described below.

The solution presented by the embodiments herein adds a complementary method that allows immediate local validation of payment. One way to achieve this is to issue the base contract with an attribute specifying an ordered list of entities that represent double spend verifiers, such as, e.g. shown in Table 1. The payer will request the issuer to include an appropriate list of verifiers according to a merchant's specification. The issuer will only redeem a promissory note that has been negotiated via the entities in the list in the specified order, thus each verifier that receives this negotiated note as payment, can be assured that the promissory note cannot be spent using a different path to the issuer. In other words, the note must pass each and every verifier on the list and if a verifier receives a note as payment, and has not accepted that note before, then it is a valid payment. In addition to expedient delivery of goods and services to consumers, local validation allows a verifier to safely collect a number of payments over time and redeem them in a single operation.

A bearer that accepts a promissory note would verify that the negotiation list contains the verifiers that are expected so far, in the correct order. In the example in FIG. 6, the merchant and the redeemer typically would be added to the list of verifiers.

For a verifier to ensure that each promissory note is only used once, records must be kept of accepted promissory. In order to keep records limited there is an Validity time attribute specified on each promissory note. After expiry, an issuer will not redeem a note so verifiers can safely forget records when they are expired.

This complementary method of using a verifiers list solves the double spending problem for merchants and redeemers. It allows them to perform immediate local validation of payment without contacting the issuer or any other central party and thus acknowledging, with low latency, a valid payment occurred. Acknowledging a valid payment might entail e.g. updating a local database to reflect that a payment was made, sending a receipt to the payer, or delivery of a product or service to a customer. Further, the local validation supports aggregation of small transactions and allows merchants and redeemers to defer requesting redemption payment until a large number of promissory notes have been accumulated.

Execute Expiry Action

Any bearer of a promissory note always has the option to let the note expire. What expiry entails is up to the issuer and the first bearer. For protocols that make use of this feature it is beneficial to have a way to add an annotation to the promissory note, send it to the issuer that can execute the expiry action immediately. However, that would bypass any double spend verifiers, and enable double spend attack.

In some embodiments, an annotation may be defined so that the issuer will only execute the expiry action on a note with this annotation, and send the note via the path through all double spend verifiers. In this case, the verifiers will negotiate the note in the standard fashion until it reaches the issuer, that will execute the expiry action.

Block Negotiation

The construction of the promissory note allows a set of promissory notes with the same bearer to be negotiated in one operation. This is done by assembling a list of the promissory notes and constructing a hash tree. The leaves of the tree are the hash values for each promissory note that would be used to sign and negotiate each promissory note by itself. The root of the hash tree is used as input for a digital signature that is included in a new negotiation record, valid for the whole block. The record structure is the same as is used to negotiate a single promissory note, e.g. as shown in Table 2. The new negotiation record is attached to the list to form the finished block. The block represents a transfer of value equal to the sum of the values of the promissory notes in the block.

Negotiate a Received Block

If a party becomes the bearer of a block of promissory notes, negotiated in this way, that party can negotiate the block to a new bearer by adding a new negotiation record.

Negotiate a Subset of a Received Block

The way the signature for a block of promissory notes is constructed, using a hash tree, it is possible to remove any leaf component and leave the signature verifiable as long a the hash value of the leaf is present instead of the leaf itself. This operation can be used to select all leaf promissory notes in a block that has the same issuer. This enables the bearer to split a block into a number of blocks, each containing promissory notes issued by the same issuer. The resulting blocks will each be negotiated to the issuer for redemption. In a similar way a bearer will want to split a block into blocks depending on the next double spend verifier.

Authenticated Payment Information

For every transfer of ownership when a promissory note, or a block of promissory notes, is negotiated to a new bearer, it is possible to supply additional information as arbitrary payment information that is sent to the new bearer. The semantics of this information can be anything agreed upon by the two parties engaged in the transfer, i.e. the current bearer and the next to become bearer. More specifically, when a consumer buys something from a merchant, the payment information could specify what is traded, e.g. an URL to some resource, the title of an e-book, the product number, order id, etc. In the construction of the promissory note, the negotiation records include a cryptographic hash value computed from the concatenation of the arbitrary payment information and a random nonce, e.g. Payment info-attribute hash in Table 2. If the arbitrary payment information together with the used nonce is sent along with a negotiation occurs, the recipient can verify that this information is authentic, or more precisely, the recipient can verify that the same party that made the payment authenticated the payment information. The Payment Info-attribute in Table 3 is used when the payment information and the nonce are supplied in this way.

Redactable Payment Information

The payment information can be redacted from a promissory note at any time without affecting the validity of the signatures as these do not cover the payment information but the computed hash values, which are still present. This enables a bearer of a promissory note to negotiate the note to a new bearer without revealing anything about what payment information was received by anyone up to this point. For anyone having access to original payment information, it is also possible to authenticate this at any later time with the access to the promissory note, even if all payment information was redacted from the note.

Coupons

Coupons are tokens that entitles the holder to receive a discount or some benefit when purchasing a product, usually exclusively at a specific merchant. The construction of promissory notes presented in this document can be used as coupons by using the double spend verifier list attribute to restrict the value of the note to one merchant. In this case the merchant buys coupons from a hub of choice and distributes them to customers. It is also possible for the merchant to issue coupons directly. The denomination, or currency, of a promissory note could be generalized to whatever the merchant wants to offer, e.g. “months of internet usage”, and with an amount of 1, such a coupon would entitle the consumer with the coupon, one month of internet usage from that particular merchant. In both cases, at expiry, the value is returned to the merchant if the coupon was not used

Refund

A refund is a consumer payment that is reversed by a merchant. This can be initiated by a consumer and motivated in a claim that something was not delivered as agreed, or by the merchant when an order cannot be completed. Refunds are assumed to only affect a small fraction of all payments. Refunds are easy to handle once the mechanisms of promissory notes in place. A way to handle refunds would be to use the issuing hub of the received payment, create a new promissory note issued to the consumer. No extra consumer credentials are needed if the refund is issued to the same public key that was used in the payment that is being refunded. Alternatively, a consumer refund public key can be supplied in the payment info for each payment. Using our promissory notes it is easy to express refunds of type money back, where the refund can be spent anywhere, and of type right to exchange, where the refund can be spent exclusively at the merchant, similar to coupons. Refund promissory notes should be valid for an appropriate duration, expected to be longer than notes used for normal payments.

Merchant Consumer Privacy Preserving Messaging Service

The consumer will frequently communicate with its selected hub and payments made will eventually be redeemed at the hub. Note that the hub could act as a communication point for merchant to the consumer. This is practical for receipts as described above, or for receiving coupons and refunds also described above. For a merchant to send a message to a consumer, the merchant would contact the issuer hub used by the consumer. This hub can be found from any payment made by the consumer. The merchant would send a message consisting of a public key of the consumer, a url where the consumer can retrieve the message, and a nonce. The consumer will connect to its hub and retrieve the url and the nonce using the public key as an mailbox address.

Using the url and adding a url parameter with a signature of the nonce as an authorisation, the consumer would retrieve the message. This has the advantage that a merchant can send messages to any consumer without requiring the registration or collecting identity information from the consumer. The merchant knows about a previous purchase of the consumer and can reward or send targeted messages to the consumer to improve the business. A consumer is expected to use different public keys for every transaction. This means that it is easy to filter out messages from specific merchants, or relating to a specific purchase. It grants consumers the power to receive messages as long as they want or to be forgotten when they want.

Proof of Existence, Upper and Lower Time Bound

Using the described construction of a promissory note and the bitcoin peer-to-peer currency block chain, a lower and upper time bound may be added to payments using promissory notes. Using the bitcoin block chain as time stamping service is not new, and there are other ways to achieve the same effect.

The point here is to show the steps needed to apply this method when using our promissory notes:

1. A way to add a lower time bound is to let the issuing hub include the hash value of the header of a recent but stable block in the bitcoin block chain, in the Payment info attribute of the initial negotiation. A block with six following blocks would be regarded as stable.

2. A way to add an upper time bound is to let the issuing hub include the hash of a redeemed promissory note in the bitcoin block chain. It follows, any payments performed with a specific promissory note must have occurred in the time window specified by the lower and upper time bounds. Assuming the bitcoin block chain is public knowledge, the requisites to demonstrate the bounds consists of:
the complete Payment info-attribute in the initial negotiation, step 1 above,
the required part of the hash tree needed to demonstrate that the root hash of the tree includes a specific promissory note, from step 2 above, and
the transaction element in the block chain that contains the tree's root hash, from step 2 above. The features used are easy to include, inside the promissory note, some data indicating the time. It is also easy to create a hash value of the completed note once it has been redeemed. The hash value may then published by the time stamping service.

Provable Properties

Using digital signatures it is possible to demonstrate the authenticity of a document. To create a digital signature the signing party has access to a secret key that no other party can access. For each secret key there exists a corresponding public key. Assuming that the digital signature scheme used is secure, then under these assumptions anyone with access to the public key can verify if a given signature of a document is signed by the party with access to the corresponding private key. This is the basic mechanism for forming a set of propositions that can be demonstrated to be true if that is the case. These propositions are constructed to be beneficial for facilitating trade over a digital channel and are described in the following sections.

Any transfer of ownership of a promissory note with some value can be regarded as a payment. In particular, a payment from a consumer to a merchant is in the form of a promissory note, negotiated to the merchant. This operation is completed when the consumer creates and adds a digital signature to the note with the new bearer. Before that step, the consumer first needs to be the bearer of a promissory note with the right amount and other attributes like issuer, validity time, etc. as required by the merchant.

One way to fill this requirement is that the consumer acquires an appropriate promissory note directly from an issuer at the time of the payment. The issuer acts as an intermediary that the user has preselected and that will make the issues requested by the consumer because the issuer has received some funds ahead of time, or is convinced he can bill the consumer at a later time, or gets paid in real-time using some other means of payment, cf. bitcoin payment channels.

Proof of Purchase, Consumer to Merchant

To make a payment, the user must negotiate a promissory note to a merchant. This involves creating a digital signature which requires access to a private key. This means that if a user, here called the demonstrator, has made a specific payment to particular merchant, he should be able to demonstrate, to the merchant, that he has access to the private key that made this payment. The steps for the demonstration that a payment was made is shown below:

1. The merchant challenges the user with a document containing a nonce.

2. The demonstrator creates a new signature of the challenge document, using the private key that was used for the payment to be demonstrated.

3. The demonstrator sends the new signature and a copy of the promissory note used as payment, to the merchant.

4. The merchant verifies if the payment has been accepted before. If this is true, the payment was real and if the signature is valid when verified with the public key in the promissory note, the demonstrator has access to the private key that made the payment.

A use case for this is when a merchant will give the right to each user that buys some content to access that content in the future if the user can demonstrate that it has been paid for previously. Other uses are possible like login authentication, claiming rebates, special offers or subscriptions. It should be noted that anyone that has access to the private key and the transaction details can make the demonstration, and the merchant will only be sure that some user made the payment and some user is demonstrating this fact. It should be noted that sometimes scope is difficult to limit, e.g. if the consumer buys an article, then the consumer can publish the key and everyone can read the article for free. This might seem equivalent to sharing a password but it is easier (less risky) to share since the key is a pseudonym and the user is anonymous. More details regarding a protocol for access rights is discussed below.

Proof of Purchase, Consumer to Anyone

There are two ways the proof above can be extended so that the demonstration can be made to outsiders that do not have access to the merchant's records. Above, the merchant can judge if the demonstrated payment in step 3 is valid by verifying, according to his own records, if this payment was previously accepted. If this verification is not performed the demonstrator can construct something that looks like a payment, in the form of a promissory note, that was never sent to the merchant. An outside observer cannot know if a payment was made or not, as there is not signature or receipt from the merchant.

Signed Receipt: With the addition of an explicit receipt, in the form of a signed document sent to the consumer from the merchant saying that the merchant accepted the promissory note as valid payment, it can be demonstrated that the merchant received a payment and the private key that made the payment can be accessed by the demonstrator.

Collect Receipt from Hub: Another way is for the consumer to use the issuing hub to collect the redeemed promissory notes as they are completed. Every promissory note that the consumer sends as payment is eventually redeemed at the issuing hub if they are redeemed. At this stage, they will contain a signature of the merchant as authentication when they were transferred from the merchant. This could be regarded as proof that the payment was accepted.

Proof of Order, Merchant to Anyone

The payment information that can be included with the payment is signed by the party making the payment as part of negotiating a promissory note to the next bearer. Assuming that the trade protocol used between a consumer and a merchant, states that the payment information attribute should include the order details of a purchase, then, in a dispute over what goods a particular payment was for, the merchant can use this information as a proof that cannot be refuted by the payer. The payer must show a proof of purchase as described in the section above, but included in this proof is a hash value of the payment information and the merchant can use his records to provide this information and demonstrate what the purchase was.

Expired Unredeemed Promissory Notes

A promissory note is a promise to pay some amount on demand. The promise will, however, be limited in time for a few reasons. Firstly, the outstanding risk will not increase to high levels if promissory notes are redeemed and completed rather than circulating for longer time as money. The design philosophy for this system is that each promissory note should be used to execute only one merchant consumer transaction and then be redeemed and completed.

Secondly, the maximum life-time of a promissory note represents a cost for record keeping against double spend attempts. As long as a specific promissory note is not expired, each double spend verifier needs to know if it has accepted that note before or not.

When a promissory note expires, the issuer's promise should not be upheld. Who is entitled to the value of the note is arguably negotiable between the issuer and the initial buyer of the promissory note. For many protocol use cases, the right to get refunded is assigned to the initial buyer at expiry, so it seems practical to have this as a default if nothing else is agreed. Any notification when an expiry has occurred, or what payment method and how the refund is requested is arbitrary and can be specified by the issuer. In any case, a refund request of an expired note should require a signature of the entitled party to authenticate the payment instruction. The is analogous to how the payment is authenticated for normal redemption.

Bitcoin Denominated Promissory Notes

In the base contract of a promissory note, the currency attribute defines the currency the amount attribute is expressing. With the aim to design a payment service that offers support for micropayments, extending down to a few US cents, a system with promissory notes denominated in bitcoin may be constructed.

Bitcoin is a digital currency that can be used to transfer value between parties over the internet, without the need for a trusted third party. In particular this means value can be transferred without intermediary banks. Bitcoin also supports a type of contract that can be cryptographically enforced. In particular, it supports a two-party contract, called payment channel, where a series of small valued transfers can be performed efficiently. Used together with digital promissory notes, a system can be put in place where consumers can engage with many services via micro-transactions, without trusting some intermediary with a sum of money upfront. Bitcoin payment channels are set up between two parties, for a specified maximum amount of time, and with a maximum amount of bitcoin that can be transferred. They also take approximately one hour to set up. The design of the payment system where a consumer preselects a hub as an issuer and facilitator for the payments, lends itself well to the use of payment channels. This allows a consumer with a digital wallet, connected to its selected hub, to buy promissory notes, paying separately for each transaction, even if these are very small. There is very little trust required between the consumer and the hub as each payment is completed irreversibly and permanently when they occur.

In a similar way when merchants demand to get paid, they could get paid over a bitcoin payment channel or with a standard bitcoin transaction if the transaction value is a large amount.

According to some aspects of embodiments herein, an object may be to provide an improved method of payment over an digital channel. Another object of embodiments herein may be to provide a method of payment with low transaction costs in which users or consumers may easily engage with a multitude of service providers via micro-transactions.

According to a further aspect of embodiments herein, a computer implemented method performed by an issuer device for enabling a payment transaction to a first bearer device on behalf of a user device is provided. The method may comprise generating a first digital information carrier. The first digital information carrier may comprise a first and a 15 second data part. The first data part may comprise information associated with an issued promissory note of an amount corresponding to the payment transaction. The term promissory note may interchangeably be referred to as contract of payment, note payable, note, or bank note. The second data part may comprise a first record. The second data part may also be referred to as a negotiation list, negotiation record, chain of negotiations, or chain of endorsements. The first record may be a record of the transfer of ownership of the issued promissory note to the user device, wherein the record is signed by an authentic digital signature using a public key of the issuer device. The method may also comprise transmitting the first digital information carrier to the user device. The method may also comprise receiving a second digital information carrier from a last bearer device, which may be the same as the first bearer device. The second digital information carrier may comprise the first data part of the first digital information carrier, and a second data part comprising a number of records. The number of records in the second data part may comprise the first record of the second data part of the first digital information carrier, and a record of each subsequent transfer of ownership of the promissory note to a bearer device up to and including the transfer of ownership of the promissory note from the last bearer device back to the issuer device, wherein each record is signed by an authentic digital signature using a public key of the previous bearer device. The method may further comprises proceeding with the redemption payment transaction to the last bearer device when each authentic digital signature of each record in the second data part in the second digital information carrier have been verified using each respective public key.

According to a yet a further aspect of embodiments herein, an issuer device for enabling a payment transaction to a first bearer device on behalf of a user device is provided. The issuer device may be configured to generate a first digital information carrier comprising: a first data part comprising information associated with an issued promissory note of an amount corresponding to the payment transaction, and a second data part comprising a first record, wherein the first record is a record of the transfer of ownership of the issued promissory note to the user device, wherein the record is signed by an authentic digital signature using a public key of the issuer device. The issuer device is configured to perform this action, e.g. by means of a generating module within the issuer device. The generating module may be part of a processor of the issuer device, or an application or computer program running on such a processor. The issuer device may also be configured to transmit the first digital information carrier to the user device. The issuer device is configured to perform this action, e.g. by means of a transmitting module within the issuer device. The transmitting module may be part of a processor of the issuer device. The issuer device may also be configured to receive a second digital information carrier from a last bearer device. The second digital information carrier may comprise the first data part of the first digital information carrier, and a second data part comprising a number of records. The number of records in the second data part may comprise the first record of the second data part of the first digital information carrier, and a record of each subsequent transfer of ownership of the promissory note to a bearer device up to and including the transfer of ownership of the promissory note from the last bearer device back to the issuer device, wherein each record is signed by an authentic digital signature using a public key of the previous bearer device. The issuer device is configured to perform this action, e.g. by means of a receiving module within the issuer device. The receiving module may be part of a processor of the issuer device. The issuer device may further be configured to proceeding with the payment transaction to the last bearer device when each authentic digital signature of each record in the second data part in the second digital information carrier have been verified using each respective public key. The issuer device is configured to perform this action, e.g. by means of a proceeding module within the issuer device. The proceeding module may be part of a processor of the issuer device, or an application or computer program running on such a processor.

According to yet another aspect of embodiments herein, a computer implemented method performed by a first bearer device for enabling a payment transaction on behalf of a user device by an issuer device is provided. The method may comprise receiving a first digital information carrier comprising a first data part and a second data part. The first data part may comprise information associated with an issued promissory note of an amount corresponding to the payment transaction. The second data part may comprise a number of records, which number of records comprises a record of each previous transfer of ownership of the promissory note to a bearer device up to and including the transfer of ownership of the promissory note to the first bearer device, wherein each record is signed by an authentic digital signature of the previous bearer device using a public key of the previous bearer device. The method may also comprise generating a second digital information carrier comprising a first data part and a second data part. The first data part may comprise the first data part of the first digital information carrier. The second data part may comprise the second data part of the first digital information carrier, wherein an additional record has been added to the number of records, which additional record is a record of the transfer of ownership of the issued promissory note to the issuer device or to another bearer device signed by an authentic digital signature using a public key of the first bearer device. The method may further comprise transmitting the second digital information carrier to the issuer device or to the other bearer device. According to another aspect of embodiments herein, the method may also comprise deferring the transmission of the second digital information carrier to the issuer device, or to the other bearer device, until a determined number of digital information carriers are ready to be transmitted to the issuer device, or to the other bearer device.

According to yet a further aspect of embodiments herein, a first bearer device for enabling a payment transaction on behalf of a user device by an issuer device is provided. The first bearer device may be configured to receive a first digital information carrier comprising: a first data part comprising information associated with an issued promissory note of an amount corresponding to the payment transaction, and a second data part comprising a number of records, which number of records comprises a record of each previous transfer of ownership of the promissory note to a bearer device up to and including the transfer of ownership of the promissory note to the first bearer device, wherein each record is signed by an authentic digital signature of the previous bearer device using a public key of the previous bearer device. The first bearer device is configured to perform this action, e.g. by means of a receiving module within the first bearer device. The receiving module may be part of a processor of the first bearer device. The first bearer device may also be configured to generate a second digital information carrier comprising a first data part and a second data part. The first data part may comprise the first data part of the first digital information carrier. The second data part may comprise the second data part of the first digital information carrier, wherein an additional record has been added to the number of records, which additional record is a record of the transfer of ownership of the issued promissory note to the issuer device or to another bearer device signed by an authentic digital signature using a public key of the first bearer device. The first bearer device is configured to perform this action, e.g. by means of a generating module within the first bearer device. The generating module may be part of a processor of the first bearer device, or an application or computer program running on such a processor. The first bearer device may further be configured to transmit the second digital information carrier to the issuer device or to the other bearer device. The first bearer device is configured to perform this action, e.g. by means of a transmitting module within the first bearer device. The transmitting module may be part of a processor of the first bearer device. According to another aspect of embodiments herein, the first bearer device may be configured to defer the transmission of the second digital information carrier to the issuer device, or to the other bearer device, until a determined number of digital information carriers are ready to be transmitted to the issuer device, or to the other bearer device. The first bearer device is configured to perform this action, e.g. by means of a deferring module within the first bearer device. The deferring module may be part of a processor of the first bearer device, or an application or computer program running on such a processor. According to a further aspect of embodiments herein, the object is achieved by system comprising at least one issuer device as described above, and at least one bearer device as described above.

According to yet a further aspect of the embodiments herein, apparatuses and methods therein for enabling a payment transaction on behalf of a user device is provided.

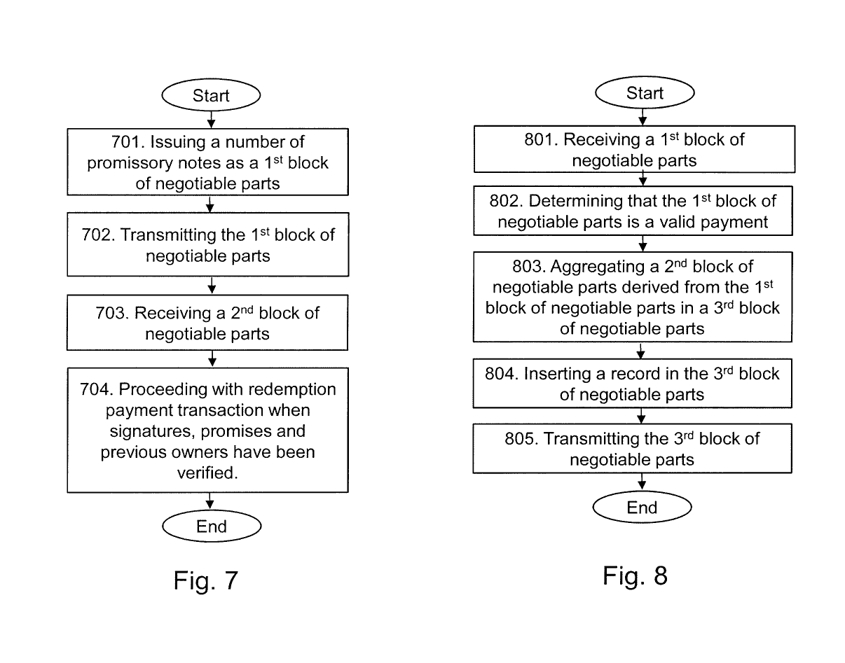

FIG. 7 shows a flowchart depicting further embodiments of a method in an issuer device 130 as described above. Here, a computer implemented method performed by an issuer device 130 for providing, to a user device 120, a number of issued promissory notes to be used as means of payment, and for enabling a last bearer device 142 to proceed with a redemption payment transaction based on issued promissory notes is described in more detail.

According to some embodiments and Action 701, the issuer device 130 issues the number of promissory notes in the form of a first block of negotiable parts. The block of negotiable parts may also be referred to as a data block of negotiable data parts. The first block of negotiable parts comprises a list of one or more promises and a record of the transfer of ownership of the issued promissory notes to the user device 120. In the list of one or more promises, each promise is associated with an issued promissory note and each promise comprises: a unique identity of the promise of the promissory note, a public key of the issuer device 130, a monetary amount, a validity time, and an ordered list of verifiers, wherein each verifier identifies a bearer device by means of a public key. The record of the transfer of ownership of the issued promissory notes to the user device 120 comprise: a public key of the user device 120, and a digital signature. The digital signature authenticates, with the public key of the issuer device 130, the record itself and the hash values of the promises in the list of promises.

According to some embodiments and Action 702, the issuer device 130 transmits the first block of negotiable parts to the user device 120.

According to some embodiments and Action 703, the issuer device 130 receives a second block of negotiable parts from a last bearer device 142. The second block of negotiable parts comprises a list of one or more negotiable parts, and a record of the transfer of ownership of all not redacted negotiable parts in the list of negotiable parts, from the last bearer device 142 back to the issuer device 130. In the list of one or more negotiable parts, each negotiable part is one of: a block of negotiable parts, which block of negotiable parts has the last bearer device 142 as its owner and promises therein, found by traversing the block of negotiable parts recursively, are issued by the issuer device 130; or a hash value computed from a redacted block of negotiable parts. The record of the transfer of ownership of all not redacted negotiable parts in the list of negotiable parts, from the last bearer device 142 back to the issuer device 130 comprises: a public key of the issuer device, and a digital signature. The digital signature authenticates, with the public key of the last bearer device 142, the record itself and hash values from the negotiable parts in the list of negotiable parts, which hash values from the negotiable parts are computed if the corresponding negotiable part is not a hash value from a redacted block.

According to some embodiments and Action 704, the issuer device 130 proceeds with the redemption payment transaction to the last bearer device 142 for the second block of negotiable parts. The payment amounts to the sum of monetary value is computed from the list of negotiable parts in the second block of negotiable parts by adding up the monetary value of promises from the issuer device 130 found by traversing the list of negotiable parts recursively. The issuer device 130 proceeds with the redemption payment transaction to the last bearer device 142 for the second block of negotiable parts when: for all blocks of negotiable parts found when traversing the list of negotiable parts recursively, the digital signature of the block itself is verified with the public key of the owner of all not redacted negotiable parts in the block itself; each promise included in the sum of monetary value is valid; no redemption payment has previously been made that includes any of the promises included in the sum of monetary value; and, for each promise included in the sum of monetary value, a computed sequence of transfer of ownership of the issued promissory note associated with the promise includes all bearer devices identified by the list of verifiers in the promise and the order of ownership of the bearer devices is the same as specified in the list of verifiers.

According to some embodiments, the digital signature in the first block of negotiable parts authenticates the hash values of the promises in the list of promises by means of a root hash of a merkle tree, wherein the merkle tree is built from the hash values. In this case, each negotiable part in the list of negotiable parts in the second block of negotiable parts may additionally be, for example, a hash value of several redacted blocks of negotiable parts computed as a root hash of a merkle tree built from several hash values from the several redacted blocks of negotiable parts.

According to some embodiments, the record of transfer of ownership in the first block of negotiable parts may further comprise a hash value of a first nonce concatenated with first additional information. In this case, the issuer device 130 may additionally transmit the first nonce and the first additional information to the user device 120. Furthermore, in this case, the issuer device 130 may further receive a second nonce and a second additional information from the last bearer device 142. Here, the record of transfer of ownership in second block of negotiable parts may further comprise a hash value of the second nonce concatenated with the second additional information.

FIG. 8 shows a flowchart depicting further embodiments of a method in a bearer device 142 as described above. Here, a computer implemented method performed by a last bearer device 142 for receiving a number of promissory notes as a means of payments and enabling a redemption payment transaction based on the promissory notes at an issuer device 130 is described in more detail.

According to some embodiments and Action 801, the last bearer device 142 receives a first block of negotiable parts from a previous bearer device 120,141. The first block of negotiable parts comprises a list of one or more negotiable parts and a record of the transfer of ownership of all not redacted negotiable parts in the list of negotiable parts, from the previous bearer device 120, 141 to the last bearer device 142. In the list of one or more negotiable parts, each negotiable part is one of: a block of negotiable parts, which block of negotiable parts has the previous bearer device 120,141 as its owner and promises found by traversing the block of negotiable parts recursively are issued by the issuer device 130; or a hash value computed from a redacted block of negotiable parts. The record of the transfer of ownership of all not redacted negotiable parts in the list of negotiable parts, from the previous bearer device 120, 141 to the last bearer device 142 comprises: a public key of the last bearer device 142, and a digital signature. The digital signature authenticates, with the public key of the previous bearer device 120,141, the record itself and hash values from the negotiable parts in the list of negotiable parts. The hash values from the negotiable parts in the list of negotiable parts are computed if the corresponding negotiable part is not a hash value from a redacted block.

According to some embodiments and Action 802, the last bearer device 142 determines that the first block of negotiable parts is a valid payment to the last bearer device 142, wherein the valid payment amounts to the sum of monetary value computed from the list of negotiable parts in the first block of negotiable parts by adding up the monetary value of promises from the issuer device 130 found by traversing the list of negotiable parts recursively. The last bearer device 142 determines that the first block of negotiable parts is a valid payment to the last bearer device 142 when: for all blocks of negotiable parts found when traversing the list of negotiable parts recursively, the digital signature of the block itself is verified with the public key of the owner of all not redacted negotiable parts in the block itself; each promise included in the sum of monetary value is valid; the ordered list of verifiers in each promise included in the sum of monetary value comprises the public key of the last bearer device 142; and, for each promise included in the sum of monetary value, a computed sequence of transfer of ownership of the issued promissory note associated with the promise includes all bearer devices identified by the list of verifiers in the promise up to the last bearer device 142 and the order of ownership of the bearer devices is the same as specified in the list of verifiers in the promise; and no promissory note of any promise included in the sum of monetary value has previously been received as payment by the last bearer device 142.

According to some embodiments and Action 803, the last bearer device 142 aggregates valid payments by forming a second block of negotiable parts by traversing recursively the list of negotiable parts in the first block of negotiable parts and redacting negotiable parts that are not issued by the issuer device 130 and replacing them with the hash value of the redacted negotiable part, and by appending the second block of negotiable parts as an element to a list of negotiable parts in a third block of negotiable parts, wherein the third block of negotiable parts is accumulating negotiable parts before the ownership of the third block of negotiable parts is transmitted to the issuer device 130.

According to some embodiments and Action 804, the last bearer device 142 inserts, when the accumulation in the third block of negotiable parts reach a determined condition, a record of the transfer of ownership to the issuer device 130 is inserted in the third block of negotiable parts. The record comprising a public key of the issuer device 130, and a digital signature. Here, the digital signature authenticates, with the public key of the last bearer device 120, 141, the record itself and hash values from the negotiable parts in the list of negotiable parts in the third block of negotiable parts. Here, the hash values from the negotiable parts are computed if the corresponding negotiable part is not a hash value from a redacted negotiable part.

According to some embodiments and Action 805, the last bearer device 142 transmits the third block of negotiable parts to the issuer device 130.

According to some embodiments, each negotiable part in the list of negotiable parts in the first blocks of negotiable parts may be a hash value of several redacted blocks of negotiable parts computed as a root hash of a merkle tree built from several hash values from the several redacted blocks of negotiable parts. Here, the digital signature in the record of transfer of ownership in the first block of negotiable parts authenticates the hash values of the promises in the list of negotiable parts by means of a root hash of a merkle tree, wherein the merkle tree is built from the hash values. In this case, the digital signature in the record of transfer of ownership inserted in the third block of negotiable parts authenticates hash values of the negotiable parts in the list of negotiable parts in the third block of negotiable parts by means of a root hash of a merkle tree, wherein the merkle tree is built from the hash values.

According to some embodiments, the last bearer device 142 further receives a first nonce and first additional information from the previous bearer device 120, 141. Here, the record of transfer of ownership in the first block of negotiable parts further comprises a hash value of the first nonce concatenated with the first additional information. In this case, according to some embodiments, the record of the transfer of ownership to the issuer device 130 may further comprise a hash value of a second nonce concatenated with second additional information. Further, according to some embodiments, the last bearer device 142 may also transmit the second nonce and the second additional information to the issuer device 130.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention. It is to be understood that the embodiments are not to be limited to the specific examples disclosed, and that modifications and other variants are intended to be included within the scope of this disclosure. Although specific terms may be employed herein, they are used in a generic and descriptive sense only and not for purposes of limitation.

What is claimed:

1. A computer implemented method performed by an issuer device for providing a promissory note as a means of payment to a user device and enabling a redemption payment transaction based on the promissory note to a last bearer device, the method comprising:
issuing a promissory note as a first digital information carrier comprising a first and second data part, wherein
the first data part comprises information associated with the promise of the promissory note, wherein the information comprises
a unique identity of the promise of the promissory note
a public key of the issuer device
a monetary amount and
a validity time, and
the second data part comprise a record of the transfer of ownership of the issued promissory note to the user device, wherein the record comprises
a public key of the user device and
a digital signature, wherein the digital signature authenticates the record and the first data part with the public key of the issuer device;
transmitting the promissory note as the first digital information carrier to the user device;
receiving the promissory note as a second digital information carrier from the last bearer device, wherein the second digital information carrier comprises:
the first data part of the first digital information carrier, and
a second data part comprising an ordered list of records in which
the first record is the record of the second data part of the first digital information carrier, and
subsequent records are any subsequent transfers of ownership of the promissory note, up to and including the transfer from the last bearer device back to the issuer device, wherein each subsequent record comprises
a public key of an assigned owner and
a digital signature of the previous owner, wherein the digital signature authenticates the record itself, the records of all previous transfers, and the first data part; and
proceeding with the redemption payment transaction based on the promissory note to the last bearer device when
the digital signature of each record in the second data part in the second digital information carrier have been verified using each respective public key,
the information associated with the promise of the promissory note in the first data part is valid, and
no redemption payment transaction has previously been made to redeem the promise of the promissory note in the first data part.

2. The method according to claim 1, wherein the first data part further comprises an ordered list of verifiers, wherein each verifier identifies a bearer device by means of a public key, and wherein the redemption payment transaction is further proceeded with when the second data part of the second digital information carrier comprises records of transfer of ownership such that all bearer devices identified by the verifiers in the first data part of the second digital information carrier are represented as previous owners and such that the order of ownership of the bearer devices is the same as specified in the ordered list of verifiers.

3. The method according to claim 1, wherein the record of the second data part of the first digital information carrier further comprises a hash value of a nonce concatenated with authenticated additional information, and wherein each record in the ordered list in the second data part of the second digital information carrier further comprises a hash value of a nonce concatenated with authenticated additional information, and wherein the redemption payment transaction is further proceeded with accorded to the authenticated additional information received from the last bearer device.

4. The method according to claim 1, wherein the issuer device is one or more nodes or servers in a communications network, which nodes or servers belongs to a legal entity authorized to issue promissory notes to a user of the user device.

5. A computer implemented method performed by a last bearer device for receiving promissory note as a means of payment and enabling a redemption payment transaction based on the promissory note at an issuer device, the method comprising:
receiving a promissory note as a first digital information carrier comprising a first and second data part, wherein
the first data part comprises information associated with the promise of the promissory note, wherein the information comprises
a unique identity of the promise of the promissory note,
a public key of the issuer device,
a monetary amount, and
a validity time, and
the second data part comprises an ordered list of records, where the ordered list comprises a record of the transfer of ownership of the issued promissory note to a user device and subsequent records of any subsequent transfers of ownership of the promissory note, up to and including the transfer from a previous bearer device to the last bearer device, wherein each record comprises
a public key of the assigned owner and
a digital signature of the previous owner, where the digital signature authenticates the record itself, the records of all previous transfers, and the first data part;
determining that the promissory note is a valid payment to the last bearer device when
the digital signature of each record in the second data part have been verified using each respective public key and
the information associated with the promise of the promissory note in the first data part is valid;
generating a second digital information carrier comprising:
the first data part of the first digital information carrier and
the second data part of the first digital information carrier, wherein an additional record is added to the ordered list of records, which additional record is a record of the transfer of ownership of the promissory note to the issuer device, wherein the additional record comprises
a public key of the issuer device and
a digital signature of the last bearer device, where the digital signature authenticates the additional record itself, the records of all previous transfers, and the first data part; and
transmitting the second digital information carrier to the issuer device.

6. The method according to claim 5, wherein the first data part of the first digital information carrier further comprises an ordered list of verifiers, wherein each verifier identifies a bearer device by means of a public key, and wherein the promissory note is determined as a valid payment to the last bearer device when:
the ordered list of verifiers in the first data part of the first digital information comprises the public key of the last bearer device,
the second data part of the first digital information further comprises records of transfer of ownership such that all bearer devices identified by the list of verifiers in the first data part of the first digital information up to the last bearer device are represented as previous owners, and such that the order of ownership of the bearer devices is the same as specified in the list of verifiers, and
no promissory note with the promise in the first data part of the first digital information has previously been received as payment.

7. The method according to claim 6, further comprising acknowledging that a valid payment has occurred, and deferring the generating and/or the transmitting of the second digital information carrier to the issuer device until a determined number of promissory notes in the form of digital information carriers are ready to be transmitted to the issuer device from the last bearer device.

8. The method of claim 5, wherein each record in the ordered list in the second data part of the first digital information carrier further comprises a hash value of a nonce concatenated with authenticated additional information, the information being transmitted from the previous to the next owner, and wherein the second digital information carrier is generated such that the additional record in the second data part of the second digital information carrier further comprises a hash value of a nonce concatenated with authenticated additional information.

9. The method according to claim 5, wherein the last bearer device is one or more nodes or servers in a communications network, which nodes or servers belongs to a merchant providing a product or service to a user of the user device.

10. A computer program product, comprising instructions which, when executed on at least one processor, cause the at least one processor to carry out the steps of:
issuing a promissory note as a first digital information carrier comprising a first and second data part, wherein
the first data part comprises information associated with the promise of the promissory note, wherein the information comprises
a unique identity of the promise of the promissory note
a public key of the issuer device
a monetary amount and
a validity time, and
the second data part comprise a record of the transfer of ownership of the issued promissory note to the user device, wherein the record comprises
a public key of the user device and
a digital signature, wherein the digital signature authenticates the record and the first data part with the public key of the issuer device;
transmitting the promissory note as the first digital information carrier to the user device;
receiving the promissory note as a second digital information carrier from the last bearer device, wherein the second digital information carrier comprises:
the first data part of the first digital information carrier, and
a second data part comprising an ordered list of records in which
the first record is the record of the second data part of the first digital information carrier, and
subsequent records are any subsequent transfers of ownership of the promissory note, up to and including the transfer from the last bearer device back to the issuer device, wherein each subsequent record comprises
a public key of an assigned owner and
a digital signature of the previous owner, wherein the digital signature authenticates the record itself, the records of all previous transfers, and the first data part; and
proceeding with the redemption payment transaction based on the promissory note to the last bearer device when
the digital signature of each record in the second data part in the second digital information carrier have been verified using each respective public key,
the information associated with the promise of the promissory note in the first data part is valid, and
no redemption payment transaction has previously been made to redeem the promise of the promissory note in the first data part.

11. A computer program product, comprising instructions which, when executed on at least one processor, cause the at least one processor to carry out the steps of:
receiving a promissory note as a first digital information carrier comprising a first and second data part, wherein
the first data part comprises information associated with the promise of the promissory note, wherein the information comprises
a unique identity of the promise of the promissory note,
a public key of the issuer device,
a monetary amount, and
a validity time, and
the second data part comprises an ordered list of records, where the ordered list comprises a record of the transfer of ownership of the issued promissory note to a user device and subsequent records of any subsequent transfers of ownership of the promissory note, up to and including the transfer from a previous bearer device to the last bearer device, wherein each record comprises
a public key of the assigned owner and
a digital signature of the previous owner, where the digital signature authenticates the record itself, the records of all previous transfers, and the first data part;
determining that the promissory note is a valid payment to the last bearer device when
the digital signature of each record in the second data part have been verified using each respective public key and
the information associated with the promise of the promissory note in the first data part is valid;
generating a second digital information carrier comprising:
the first data part of the first digital information carrier and
the second data part of the first digital information carrier, wherein an additional record has been added to the ordered list of records, which additional record is a record of the transfer of ownership of the promissory note to the issuer device, wherein the additional record comprises
a public key of the issuer device and
a digital signature of the last bearer device, where the digital signature authenticates the additional record itself, the records of all previous transfers, and the first data part; and
transmitting the second digital information carrier to the issuer device.
